(19) United States
(12) Patent Application Publication
(10) Pub. No.: US 2007/0290035 A1
(43) Pub. Date: Dec. 20, 2007

(54) SYSTEM AND METHODS FOR PROCESSING PRIVATE TRANSACTIONS WITH AN ACCESS INSTRUMENT

(76) Inventors: Maria Gaos, Bothell, WA (US); Nazih Youssef, Bothell, WA (US)

Correspondence Address: AXIOS LAW GROUP. PLLC, 1525 FOURTH AVENUE, SUITE 800, SEATTLE, WA, 98101, US

(21) Appl. No.: 11/764,097

(22) Filed: Jun. 15, 2007

Related U.S. Application Data
(60) Provisional application No. 60/804,912, filed on Jun. 15, 2006.

(51) Int. Cl. G06K 5/00; G06Q 40/00

(52) U.S. Cl. 235/380; 235/382; 705/44; 705/64

(57) ABSTRACT

A system and methods for processing transactions with an access instrument having a first plurality of user-specific account information stored thereon. A transaction is initiated upon request from a user and the requesting user is authenticated from a second plurality of user-specific information and the first plurality of user-specific account information. An account status is confirmed for the user from a third plurality of user-specific account information. The requested transaction is completed after authentication of the user and confirmation of the account access status.

### CROSS-REFERENCE TO RELATED APPLICATIONS

This application is based upon and claims the benefit of priority from Provisional Application No. 60/804,912 filed Jun. 15, 2006, the entire contents of which are incorporated herein by reference.

### FIELD

The present disclosure relates generally to computing and communications for privatizing transactions, and in particular but not exclusively, relates to a system and methods for issuing financial instruments and processing financial transactions in a secure, private and distributed operating environment.

### BACKGROUND

The widespread generation and dissemination of private information that has been made possible by dramatic advances in computing and communications technologies enables the distribution of private information to many unauthorized and unknown third parties. There is a pressing need for some means of controlling the unfettered access to one's private information and for technologies that can limit the distribution of such information to such parties.

As an example, the financial backbone of most modern economies in the 21^{st} century is based in significant part on credit. Indeed, a wide variety of personal and commercial transactions are enabled by the widespread availability of credit as a means for consummating commercial transactions. The current system of credit issuance and approval often involves the compilation of a user's complete record of transactions, which record is commonly made available in whole to all issuers of credit. Although such issuers have a legitimate interest in reviewing and monitoring the credit records of users of the financial instruments they issue, it is debatable whether such issuers should be permitted to have access to a user's credit records involving financial instruments that were not issued by a reviewing credit issuer. Nonetheless, the dissemination of a user's complete record of credit transactions occurs on a widespread basis, the nature of the record disseminated is such that not only is the complete record of transactions disclosed to financial instrument issuers but also the identity of the account holder.

No present means exist to enable the account holder to retain control over an entire record of transactions and to regulate in any effective manner the extent to which portions of the record are made accessible to third party financial instrument issuers or associated transaction approval centers. Although such issuers do permit account holders to establish personal identification numbers for their issued instruments, such identification numbers presently do not enable an account holder to set variable levels of security and to control the use of such instruments by authorized third parties.

Thus, there is a need for a system and methods that permit an authorized holder of an access instrument to adopt an anonymous identity, to have the ability to set variable levels of secured access to private accounts and to preclude the unknowing and often unauthorized dissemination of personal information included in an integrated record of transactions, such as a holder's financial transactions.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating a computing and communications infrastructure comprised of multiple geographic regions for a distributed network of regional operation and control centers in an embodiment.

FIG. 2 is a flow chart illustrating a process of issuing an access instrument in an embodiment.

FIG. 3A is a diagram illustrating the fields included in a user address record in an embodiment.

FIG. 3B is a diagram illustrating the fields included in a user access record in an embodiment.

FIG. 3C is a diagram illustrating the fields included in a user security record in an embodiment.

FIG. 4A is a flow chart illustrating a method of processing a transaction with an access instrument in an embodiment.

FIG. 4B is a continuation of the flow chart depicted in FIG. 4A illustrating the method of processing a transaction with an access instrument.

### DETAILED DESCRIPTION

Various embodiments of the present disclosure provide a system and methods for issuing and processing access instruments that include private information, such as private financial accounts or other confidential information stored in electronic files, in a manner that provides anonymity and complete isolation of the private information. The system and methods provide for the creation of unique user identifiers to enhance personal privacy, the compilation of financial, business or other private information in a discrete and isolated manner, the use of variable access restrictions and the distributed storage of private information in a computing and communications infrastructure that supports the segregation and isolation of account information to prevent the widespread dissemination of private information in a wholesale and integrated fashion to unauthorized third parties.

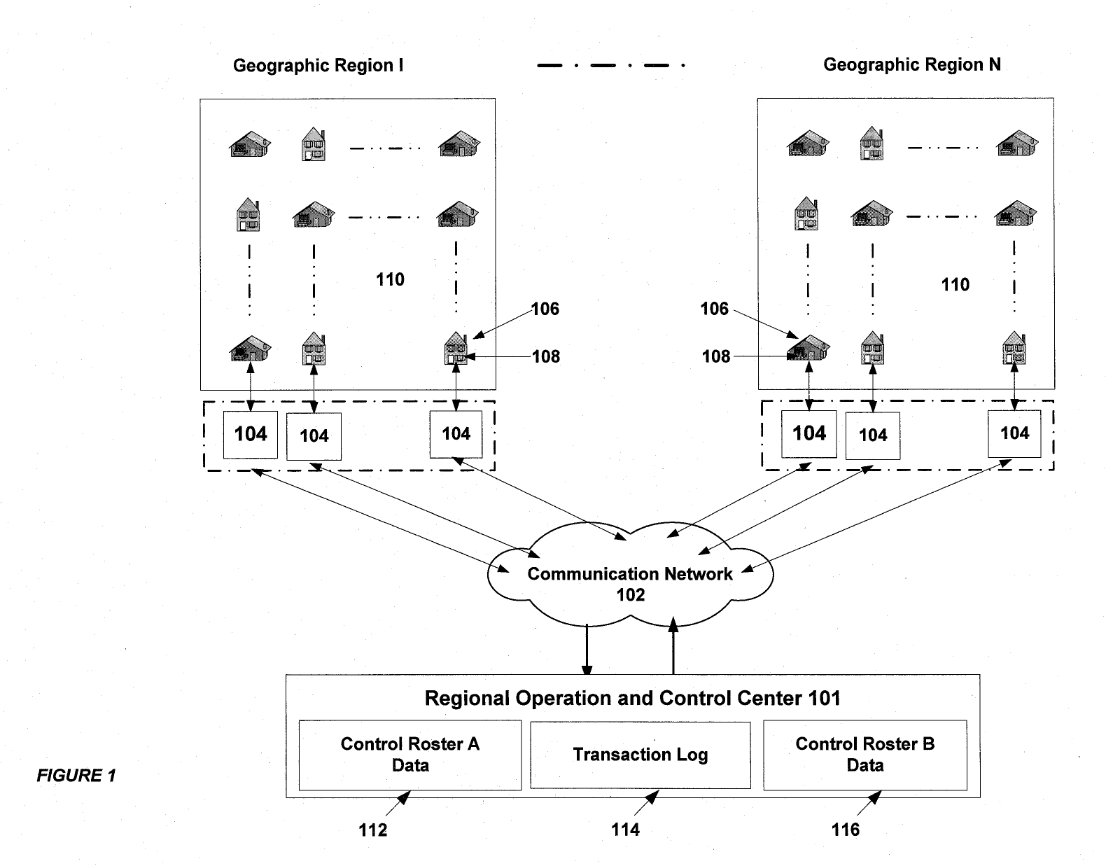

FIG. 1 illustrates a system comprised of a plurality of geographic regions 110 controlled by a Regional Operation and Control Center 101. Each geographic region 110 includes a plurality of homes, buildings and other geographic locations 106. As shown in this figure, Geographic Region I is comprised of multiple houses and properties, in one such property 106 an electronic device 108 is included that is used by one or more household members. The plurality of geographic regions 110 is serviced by the Regional Operation and Control Center 101 through communication network 102 and a plurality of intermediate processing nodes 104. The electronic devices 108 communicate with the Regional Operation and Control Center 101 through intermediate processing nodes 104 and the communication network 102 for the selection, execution and completion of various financial transactions. Each electronic device 108 provides its user with the ability to pursue various financial transactions while preserving the anonymity of each user. A plurality of users may be assigned to use a particular electronic device 108 in each household, building or location 106. The location 106 indicated in each geographic region 110 represents households, buildings, businesses, offices and other locations where people may be engaged in the use of one or more electronic devices or access instruments associated with the electronic device 108.

In the Regional Operation and Control Center 101, several different data stores are included. Data in Control Roster A (112), transaction log (114) and data in Control Roster B (116) are stored in separate data stores provided in Regional Operation and Control Center 101. The data in Control Roster A (112) includes user specific data that remains stored in Regional Operation and Control Center 101. The data in Control Roster B (116) includes a separate set of user specific data to be described later. The transaction log 114 stores an electronic record of all transactions completed by access instruments associated with a particular electronic device 108 whose user will also have relevant transaction data in Control Roster A (112) and Control Roster B (116). In an embodiment, each Regional Operation and Control Center 101 is coupled to one or more transaction Approval Centers (not shown) that confirm and approve financial and other pertinent financial transactions for users of access instruments associated with an electronic device 108.

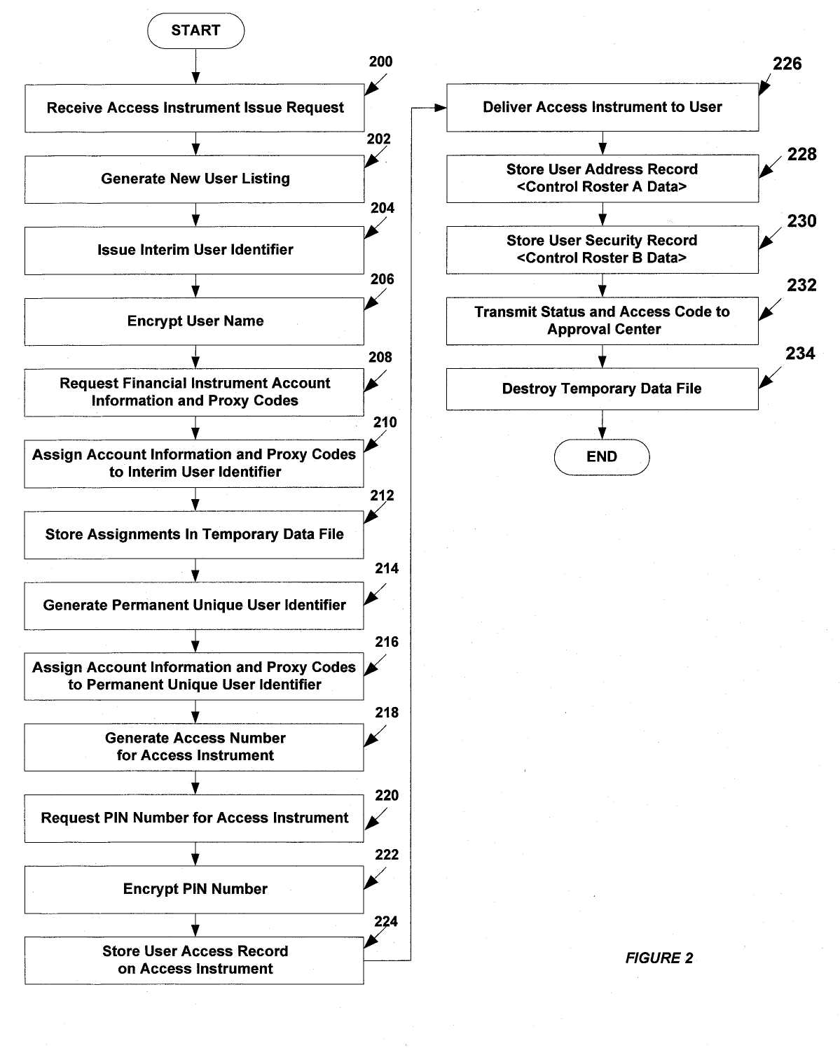

FIG. 2 illustrates a process for issuing an access instrument used by an end user. In representative embodiments, the access instrument can implemented as a read-only memory, smart card, flash drive, bar code card, thumb drive, encoded magnetic strip or compact disk. In an alternative embodiment, the access instrument is a computer program product that includes a user identifier component and a user address component. The user identifier component stores and maintains user identifiers and the user address component maintains the address data that is associated with each user identifier.

In the disclosed computing and communications infrastructure, an access instrument is used to facilitate and complete a wide variety of commercial transactions with complete privacy, maximum information security and enforced assurance that a user's complete and integrated transaction history will not be compiled or distributed to third party information gatherers or financial instrument issuers. In one embodiment, an access instrument is associated with a specific user independent of a specific electronic device 108 and certain unique user identifiers are generated from knowledge of the user's actual identity. Multiple dependent access instruments may also be created when a primary access instrument is created for that specific user, with each dependent access instrument having different associated financial instruments and access status restrictions. In an alternative embodiment, the access instrument is associated with a specific electronic device 108 and certain user identifiers are generated for one or more users based only on knowledge of the electronic device 108 with which such users are associated. In this embodiment, a hierarchy of access rights and restrictions can be created and enforced that permits multiple dependent access instruments to be created for multiple users when a primary access instrument is created and associated with a particular electronic device 108.

The process starts when a request is received by Regional Operation and Control Center 101 to issue a new access instrument, as shown at step 200. Upon receipt of a request, a new user listing is generated (step 202) for processing by the Regional Operation and Control Center 101. The internal processing performed by the Center 101 results in the issuance of an interim user identifier, as shown at step 204, and the encryption of the user's name, as shown at step 206. A human operator in the Regional Operation and Control Center 101 will issue a request for information relating the financial instruments to be associated with the access instrument. This will include a request for specific financial account numbers (e.g., credit card numbers, business line of credit numbers, etc.) and one or more proxy codes that may be user created (step 208). After receipt of the financial instrument account information and relevant proxy codes, a logical assignment will be performed by compiling the received data into a database and creating a numerical and logical association between the account information, each proxy code and the interim user identifier, as shown at step 210.

After assigning the account information and proxy codes to the interim user identifier (step 210), the assignments are stored in a temporary data file, as shown at step 212. Afterwards, a permanent unique user identifier will be generated, (step 214) that will become permanently associated with the user and the user's stored data. Later, the account information and proxy codes specified by the user will be assigned to the permanent unique user identifier, as shown at step 216. After assignment of these codes and information to the identifier, an access number will be generated by the Regional Operation and Control Center 101 for the new access instrument, as shown at step 218. The request for financial instrument account information and proxy codes shown at step 208 also includes a request for an optional personal identification number for the access instrument, which PIN number will be assigned to the access instrument, if provided, at step 220. In an embodiment, the PIN may be created by the user, while in other embodiments the PIN may be system created upon request by the human operator in the Center 101. An encrypted PIN number will be created (step 222) from the newly generated PIN and stored in a User Security Record. In an alternative embodiment, an access instrument may be created with no PIN assigned that provides a minimum number of financial instruments to be accessed with a default setting. Access to this type of access instruments can be established by either a user-specified or system-generated set of access codes.

In an embodiment, upon creation of the encrypted PIN number, the entries in a User Access Record will be stored on the access instrument, as shown at step 224. The User Access Record includes fields to store the permanent user identifier, one or more proxy codes, an account status code, and one or more access codes for each financial instrument owned by the user. After storage of the User Access Record, the new access instrument will be delivered to the user, as shown at step 226, by a conventional means of delivery such as US Mail or Federal Express, etc. in an embodiment. In addition, the User Address Record will be stored in Control Roster A (112), which is shown at step 228. The User Address Record in an embodiment includes a field for the permanent user identifier and one or more fields for the user's address data. In addition, a User Security Record will be stored in Control Roster B (116), as shown at step 230. In an embodiment, the User Security Record will include fields for at least a permanent user identifier, one or more proxy codes, an encrypted user name, and the encrypted PIN number. After storage of the three different forms of records, the Regional Operation and Control Center 101 will transmit status and access code data to the Approval Center, as shown at step 232. After transmission of this data, the temporary data file that was used initially to form an assignment between the user's account information, the proxy code(s) and the interim user identifier will be destroyed at the Regional Operation and Control Center 101, as shown at step 234.

Although the location of a User Access Record, a User Address Record and a User Security Record may vary in different embodiments, in the disclosed embodiment the proxy codes are user created, each access code may be system created or user created, and each of the access codes are used to set restrictions on each financial instrument associated with the access instrument. The purpose of the access instrument is to provide maximum privacy and security for the private information and financial accounts of a user, whether those accounts be personal credit cards, business lines of credit, other forms of commercial accounts, or other forms of a user's private information (e.g. medical records, etc.).

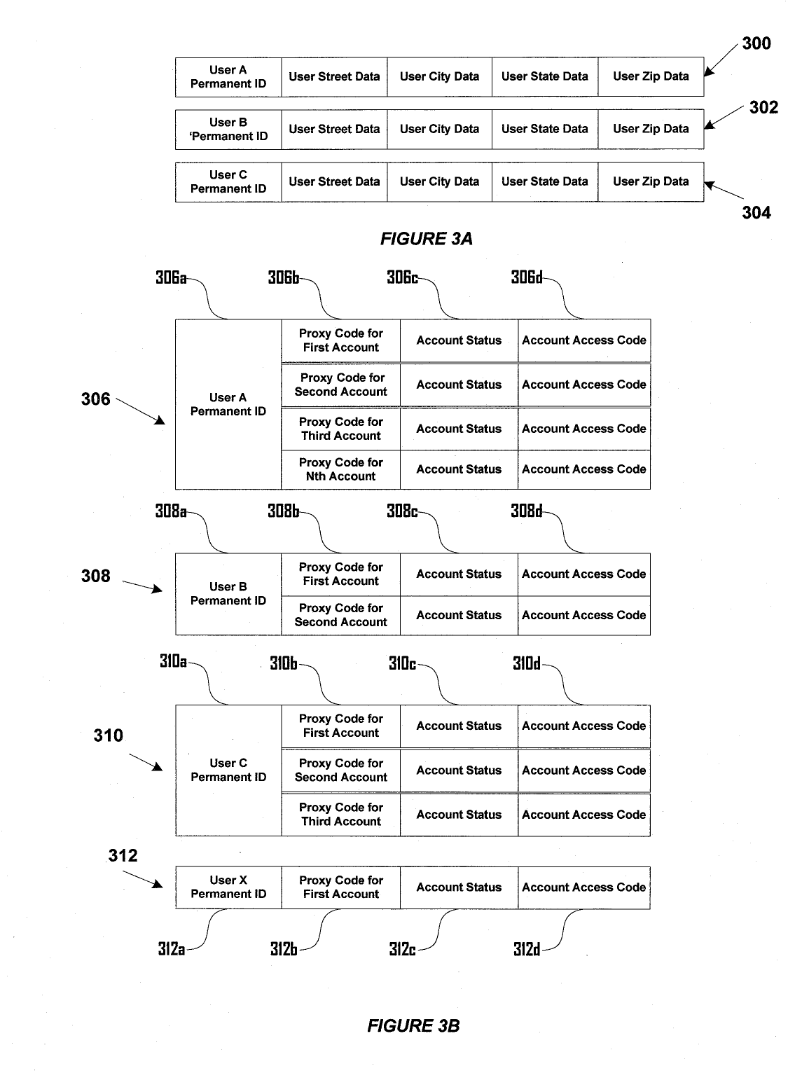

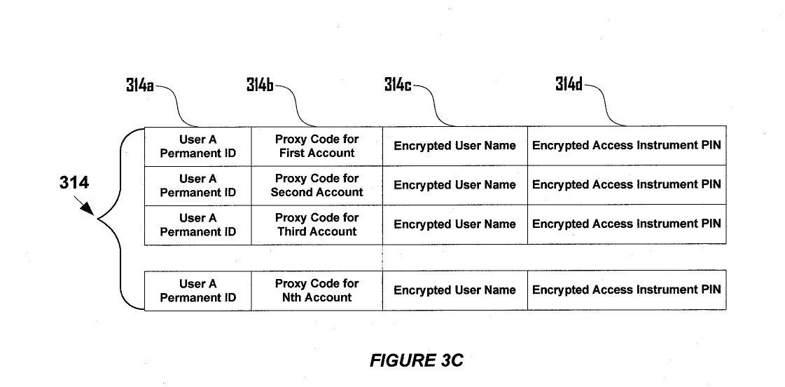

FIG. 3A is an illustration of a User Address Record for three different hypothetical users. The first User Address Record 300 illustrates several different fields, one field specifying the permanent unique user identifier for user A and several fields identifying the address data of that user such as the user street data, the user city data, and state and zip code information. User Address Record 302 is a representative illustration of a User Address Record for user B which also includes a field for a permanent unique user identifier and relevant address information. User Address Record 304 is an illustration of a record for user C which includes a field for a permanent unique user identifier and the user's street data, city data, and state and zip code information.

FIG. 3B illustrates several examples of User Access Records. In the first example, User Access Record 306 includes several fields, including a field for a permanent unique user identifier for user A 306a, a plurality of fields for proxy codes for different accounts owned by user A, as shown in column 306b, and a plurality of fields representing the access status available to user A for each account, as shown in column 306c, and a plurality of account access codes for each account owned by user A, as shown in column 306d. The second column identifying proxy codes 306b includes separate fields for each of the different accounts owned by user A. In an embodiment, a proxy code is provided for a first account, a second account, a third account and so on up to any number of accounts that are associated with or owned by user A. The access status 306c data indicates whether the particular financial account is “open” or “closed.” Each of the account access codes can be system created or user created and are used to set restrictions on the ability of the user to access a particular account. In this instance, user A has a first account which is represented in the User Access Record 306 by a proxy code (shown in column 306b) and associated with the permanent unique user identifier shown in column 306a. This first account has an account status 306c and an account access code 306d that must be used by user A to gain access to the first account represented by the stored proxy code. In this embodiment, user A may request and obtain an access instrument that has different associated financial accounts with different levels of access set by different access codes.

User Access Record 308 for user B includes the same columns as those shown in User Access Record 306. Therefore, column 308a represents the field for storing the permanent unique user identifier for user B, column 308b includes the proxy codes for a first account and a second account owned by user B. Column 308c includes the account status for each account owned by user B and column 308d includes the account access code for each account owned by user B and specified by a proxy code shown in column 308b. Likewise, the User Access Record 310 for user C includes a permanent unique user identifier, as shown in column 310a, columns and fields for proxy codes, account status, and account access codes as represented by columns 310b, 310c, and 310d, respectively. Lastly, in this illustration, User Access Record 312 for user X includes a permanent unique user identifier stored in the field 312a and only a single account proxy code shown in field 312b. This account has an entry for account status 312c and an account access code 312d that sets or limits the scope of user X's ability to access resources available on the first account represented by the proxy code included in column 312b.

FIG. 3C is an illustration of a User Security Record 314 for user A. As shown, column 314a includes the permanent unique user identifier for user A and column 314b includes proxy codes for each of the different accounts owned by user A. In this example, there are N different accounts owned by user A. In column 314c, the encrypted user name for user A is stored and in column 314d the encrypted access instrument PIN is stored for each account. The encrypted PIN number for an access instrument enables a user to have access to one or more of the accounts associated with the access instrument, which accounts are represented by proxy codes that are assigned to the permanent unique user identifier for the designated user. Thus, proxy codes specify a specific financial instrument and access codes specify restrictions and provide access to a financial instrument (e.g. a credit card or business line of credit).

In addition to the foregoing, hierarchies can be established among access instruments created for a particular user or associated with a particular electronic device 108. For instance, there may a Primary access instrument and a plurality of Secondary access instruments associated with the Primary instrument. In one embodiment, only the owner of the Primary access instrument may set or restrict the degree of access a user of a Secondary access instrument may have to one or more financial instruments. Such restrictions are implemented by the choice of access codes which may be created by the owner of the Primary access instrument and used to set the limits, terms or other conditions on usage of certain financial instruments associated with one or more Secondary access instruments.

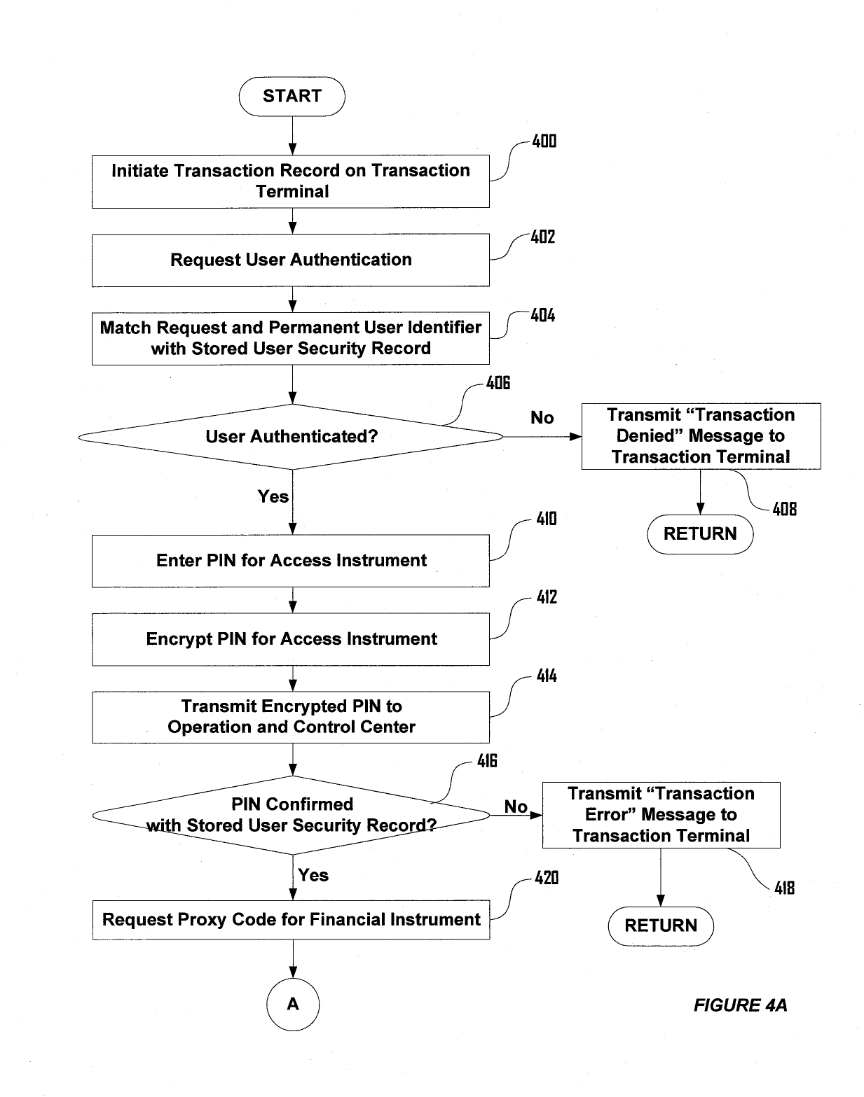

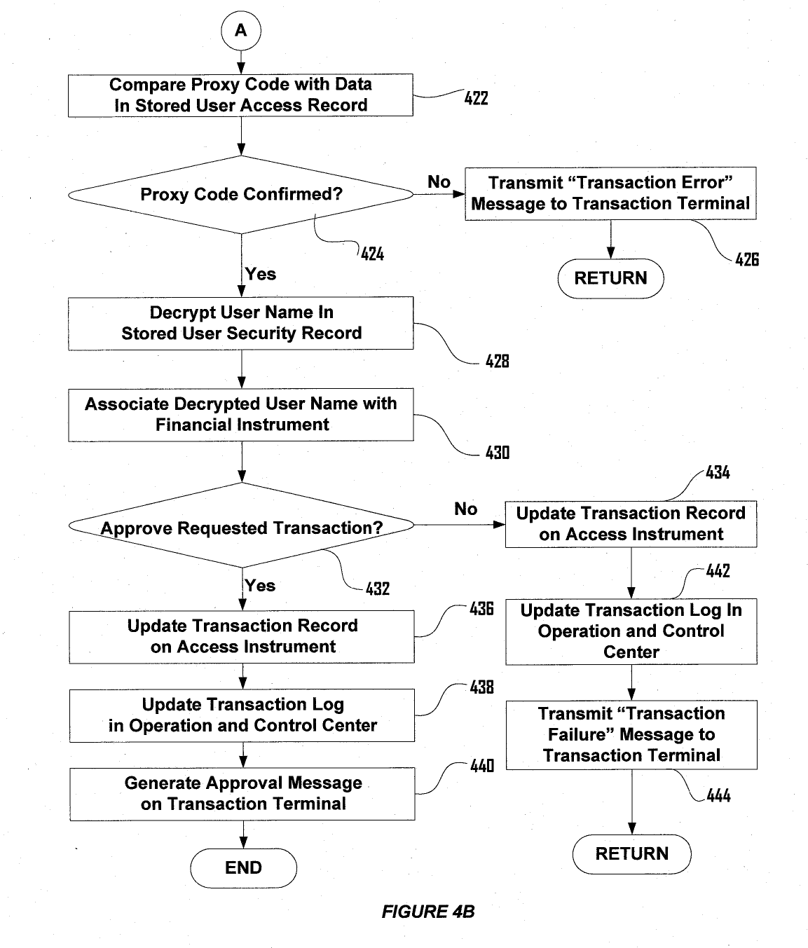

FIGS. 4A and 4B illustrate an embodiment of a method for processing a transaction involving the use of an access instrument. The processing of a transaction request commences with the initiation of a transaction record on a transaction terminal, as shown at step 400. The transaction terminal may be a portable device or a fixed device at a merchant's location. Upon initiation of the transaction, a request is made to the Regional Operation and Control Center 101 to authenticate the user of the access instrument, as shown at step 402. The user authentication request and the permanent unique user identifier associated with the access instrument used to commence the transaction are compared with the data stored in the User Security Record, as shown at step 404. A process is performed by the Regional Operation and Control Center 101 to determine whether the user can be authenticated, as shown at step 406. If the user cannot be authenticated by the Regional Operation and Control Center 101, then a “transaction denied” message will be transmitted to the transaction terminal as shown at step 408.

On the other hand, if the user is authenticated, the Center 101 will issue a request for the user to enter a PIN number for the access instrument, as shown at step 410. Once received at the merchant's terminal, the PIN number will be encrypted as shown at step 412 and transmitted to the Regional Operation and Control Center 101, as shown at step 414. If the PIN number is confirmed with the data stored in Control Roster B (116) of the User Security Record at the Regional Operation and Control Center 101, then the Center 101 will request the proxy code for the specific financial instrument that is to be used for the transaction, as shown at step 420. If the PIN number cannot be confirmed, the Center 101 will transmit a “transaction error” message to the transaction terminal as shown at step 418 and end the transaction request.

After receipt of a proxy code for a particular financial instrument, it will be compared with the data stored in the User Access Record. If this proxy code can be confirmed (shown at step 424), then the user name stored in the User Security Record will be decrypted as shown at step 428. Afterwards, the decrypted user name will be associated with the financial instrument information represented by the proxy code, as shown at step 430. The financial instrument information is an account number for a financial instrument in one embodiment. This is the first and only time in a transaction that an association is made between a decrypted user name and a financial instrument information. In one embodiment, the Regional Operation and Control Center 101 will then facilitate the approval of the requested transaction (as shown at step 432) by providing the association data (i.e., the decrypted user name and the associated financial instrument information) to an Approval Center. In an alternative embodiment, the permanent unique user identifier will be provided in lieu of the decrypted user name along with the associated financial instrument information.

Once the association data is received, the Regional Operation and Control Center 101 will be in communication with an Approval Center having the access code and account status information for the relevant financial instrument. The Center 101 does not have the authority to approve requested transactions, but communicates with and obtains approval from the Approval Center. The Approval Center will communicate with the financial instrument issuer as necessary to confirm the account status of the financial instrument indicated by the user of the access instrument.

If the requested transaction is approved, as shown at step 432, a transaction record on the access instrument and the transaction log 114 in the Regional Operation and Control Center 101 will be updated, as shown at steps 436 and 438, respectively. The Regional Operation and Control Center 101 will then generate an approval message on the transaction terminal at the merchant's location, as shown at step 440. After confirmation of the transaction, all data associated with the transaction at the Regional Operation and Control Center 101 involving the use of the decrypted user name will be destroyed permanently.

If the requested transaction is not approved (step 432), the transaction record on the access instrument will be updated (step 434) and the transaction log 114 in the Center 101 will be updated, as shown at step 442. The Center 101 will transmit a “transaction failure” message to the merchant's terminal (step 444) and the process will return.

In an alternative embodiment, additional steps will be performed before the decryption of a user's name, as shown at step 428, and the association of the decrypted user's name and a specific financial instrument occur. In this alternative embodiment, a request will be made for an access code of a specific financial instrument and a comparison will be performed of the provided access code with the data stored in the requesting user's User Access Record. After a comparison and match are obtained between three different levels of security (i.e., correct PIN number, proxy code and access code), only then will an association be formed between a decrypted user name and the specified financial instrument, as shown at step 430.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein including applications of the system and methods to other forms of private, sensitive or otherwise personal information. It is to be understood that any particular embodiment shown and described by way of illustration is in no way intended to be limiting and references to details of various embodiments are not intended to limit the scope of the claims presented below.

What I claim is:

1. A method for processing transactions, the method comprising:
providing an access instrument having a first plurality of user-specific account information stored thereon;
obtaining a request from a user to initiate a transaction using the access instrument;
authenticating the user of the access instrument from a second plurality of user-specific information and the first plurality of user-specific account information;
confirming an account access status for the user requesting initiation of the transaction from a third plurality of user-specific account information; and
completing the requested transaction after authenticating the user and confirming the account access status.

2. The method of claim 1 wherein at least one financial instrument is associated with the access instrument.

3. The method of claim 2 wherein the at least one financial instrument comprises one or more of a personal credit card, a business credit card, a business line of credit and a commercial account.

4. The method of claim 1 wherein the first plurality of user-specific account information comprises a user address record, the user address record having a permanent user identifier field and a plurality of user address data fields.

5. The method of claim 1 wherein the authenticating of the user of the access instrument comprises:
receiving a request to process a transaction; and
matching a permanent user identifier stored in a first data field of the first plurality of user-specific account information and a permanent user identifier stored in a first data field of the second plurality of user-specific account information.

6. The method of claim 5 wherein the authenticating of the user of the access instrument further comprises:
receiving a proxy code from the user;
comparing the proxy code received from the user with a proxy code field included in the second plurality of user-specific account information;
confirming an association between the proxy code and the permanent user identifier stored in the first data field of the second plurality of user-specific account information.

7. The method of claim 1 wherein the second plurality of user-specific information comprises a user security record, the user security record including at least one of a permanent user identifier field, a proxy code field, an encrypted user name field and an encrypted access instrument personal identification number (PIN).

8. The method of claim 1 wherein the third plurality of user-specific account information comprises a user access record, the user access record including a permanent user identifier field, a proxy code field, an account status field and an account access code field,
the proxy code field including a proxy code operative to prevent disclosure of a permanent user identifier stored in the permanent user identifier field, the proxy code associated with the permanent user identifier,
the account status field operative to indicate a status of an account associated with the access instrument, and
the account access code field operative to store an account access code for the user having the proxy code associated with the permanent user identifier.

9. The method of claim 1 wherein completing the requested transaction comprises:
associating a proxy code included in a user access record with a permanent user identifier;
retrieving an account number based on the proxy code;
decrypting an encrypted user name stored in a user security record; and
transmitting the account number and the decrypted user name to an approval center.

10. The method of claim 1 wherein completing the requested transaction comprises:
associating a proxy code included in a user access record with a permanent user identifier;
retrieving an account number based on the associated proxy code; and
transmitting the account number and the permanent user identifier to an approval center.

11. The method of claim 1 wherein the transaction requested from the user is at least one of a financial transaction and an information disclosure transaction.

12. The method of claim 11 wherein the information included in the information disclosure transaction includes confidential information.

13. The method of claim 11 wherein the information included in the information disclosure transaction includes medical records.

14. The method of claim 1 wherein the access instrument comprises at least one of a read-only memory, smart card, flash drive, bar code card, thumb drive, encoded magnetic strip and compact disk.

15. The method of claim 1 wherein the access instrument comprises a computer program product, the computer program product comprising:
a user identifier component operative to store and maintain one or more permanent user identifiers in a plurality of user address records; and
a user address component operative to maintain a plurality of data fields including user address data for each permanent user identifier stored in each of the plurality of user address records.

16. A system for processing transactions, the system comprising:
at least one access instrument operative to initiate a user-requested transaction, each access instrument having a storage medium, the storage medium including a first plurality of user-specific account information;
an electronic device coupled to the at least one access instrument, the electronic device operative to maintain an association with the at least one access instrument; and
a control center coupled to the electronic device, the control center operative to maintain a second plurality of user-specific information and a third plurality of user-specific account information and to process the user-requested transaction initiated on the at least one access instrument.

17. The system of claim 16 wherein at least one financial instrument is associated with the at least one access instrument.

18. The system of claim 17 wherein the at least one financial instrument comprises one or more of a personal credit card, a business credit card, a business line of credit and a commercial account.

19. The system of claim 16 wherein the first plurality of user-specific account information comprises a user address record, the user address record having a permanent user identifier field and a plurality of user address data fields.

20. The system of claim 16 wherein the control center is further operative to authenticate a user of the at least one access instrument.

21. The system of claim 16 wherein the control center is further operative to maintain a transaction log for each user-requested transaction initiated using the at least one access instrument.

22. The system of claim 16 wherein the second plurality of user-specific information maintained in the control center comprises a user security record, the user security record including at least one of a permanent user identifier field, a proxy code field, an encrypted user name field and an encrypted access instrument personal identification number (PIN).

23. The system of claim 16 wherein the third plurality of user-specific account information comprises a user access record, the user access record including a permanent user identifier field, a proxy code field, an account status field and an account access code field, the proxy code field including a proxy code operative to prevent disclosure of a permanent user identifier stored in the permanent user identifier field, the proxy code associated with the permanent user identifier, the account status field operative to indicate a status of an account associated with the access instrument, and the account access code field operative to store an account access code for the user having the proxy code associated with the permanent user identifier.

24. The system of claim 16 wherein the control center is operative to:
associate a proxy code included in a user access record with a permanent user identifier;
retrieve an account number based on the proxy code;
decrypt an encrypted user name stored in a user security record; and
transmit the account number and the decrypted user name to an approval center to process the user-requested transaction.

25. The system of claim 16 wherein the control center is operative to:
associate a proxy code included in a user access record with a permanent user identifier;
retrieve an account number based on the associated proxy code; and
transmit the account number and the permanent user identifier to an approval center to process the user-requested transaction.

26. The system of claim 16 wherein the user-requested transaction is at least one of a financial transaction and an information disclosure transaction.

27. The system of claim 26 wherein the information included in the information disclosure transaction includes confidential information.

28. The system of claim 26 wherein the information included in the information disclosure transaction includes medical records.

29. The system of claim 16 wherein the at least one access instrument comprises at least one of a read-only memory, smart card, flash drive, bar code card, thumb drive, encoded magnetic strip and compact disk.

30. The system of claim 16 wherein the at least one access instrument comprises a computer program product, the computer program product comprising:
a user identifier component operative to store and maintain one or more permanent user identifiers in a plurality of user address records; and
a user address component operative to maintain a plurality of data fields including user address data for each permanent user identifier stored in each of the plurality of user address records.

31. A computer readable medium having instructions for:
obtaining a request from a user to initiate a transaction using an access instrument, the access instrument having a memory for storing a first plurality of user-specific account information;
authenticating the user of the access instrument from a second plurality of user-specific information and the first plurality of user-specific account information;
confirming an account access status for the user requesting initiation of the transaction from a third plurality of user-specific account information; and
completing the requested transaction after authenticating the user and confirming the account access status.
